(19) United States
(12) Patent Application Publication
(10) Pub. No.: US 2026/0196113 A1
(43) Pub. Date: Jul. 9, 2026

(54) ILLUSIONARY TACTILE FORCE GENERATING DEVICE

(71) Applicant: Murata Manufacturing Co., Ltd., Nagaokakyo-shi (JP)

(72) Inventor: Keito Kito, Nagaokakyo-shi (JP)

(21) Appl. No.: 19/557,286

(22) Filed: Mar. 5, 2026

Related U.S. Application Data
(63) Continuation of application No. PCT/JP2024/028226, filed on Aug. 7, 2024.

(30) Foreign Application Priority Data
Nov. 14, 2023 (JP) 2023-193540

(51) Int. Cl. G08B 6/00

(52) U.S. Cl. CPC G08B 6/00

(57) ABSTRACT

An illusionary tactile force generating device gives a first illusionary tactile force and a second illusionary tactile force different from each other. The illusionary tactile force generating device includes a vibration generator, a vibration generator, an attachment unit, and an attachment unit. The vibration generator generates a first vibration for generating the first illusionary tactile force. The vibration generator generates a second vibration for generating the second illusionary tactile force. The attachment unit allows the vibration generator to be attached to an index finger of a hand of a user. The attachment unit allows the vibration generator to be attached to the index finger. The first vibration and the second vibration are vibrations different from each other. The attachment unit and the attachment unit are disposed at different positions in a direction in which the index finger extends.

### CROSS REFERENCE TO RELATED APPLICATIONS

This application is a continuation of International Application No. PCT/JP2024/028226, filed Aug. 7, 2024, which claims priority to Japanese Patent Application No. 2023-193540, filed Nov. 14, 2023, the entire contents of each of which are hereby incorporated in their entirety

### TECHNICAL FIELD

The present disclosure is directed to a technology that gives an illusionary tactile sensation to a user.

### BACKGROUND

Japanese Unexamined Patent Application Publication No. 2020-102279 (the “'279 Publication”) describes a tactile force information presentation system. The tactile force information presentation system described therein includes a housing held by a user. A vibrator is accommodated in the housing. A part of the vibrator is exposed from the housing.

The user receives a tactile force by touching the vibrator while holding the housing.

However, in the configuration described in the '279 Publication, the user needs to hold the housing that generates a tactile force. This restricts the user's actions. For example, the user cannot receive a tactile force while touching or holding another object in his or her hand. In addition, in this configuration, it is difficult to achieve a plurality of types of tactile forces with a simple structure.

### SUMMARY OF THE INVENTION

According to an aspect of the disclosure is to provide an illusionary tactile force generating device having a simple structure that can give a plurality of types of illusionary tactile forces while reducing restrictions on the user's actions.

The present disclosure provides an illusionary tactile force generating device capable of giving a first illusionary tactile force and a second illusionary tactile force different from each other. The illusionary tactile force generating device includes a first vibration generator, a second vibration generator, a first attachment unit, and a second attachment unit. The first vibration generator generates a first vibration for generating the first illusionary tactile force. The second vibration generator generates a second vibration for generating the second illusionary tactile force. The first attachment unit allows the first vibration generator to be attached to a finger that is any finger of a hand of a user. The second attachment unit allows the second vibration generator to be attached to the finger. The first vibration and the second vibration are vibrations different from each other. The first attachment unit and the second attachment unit are disposed at different positions in a direction in which the finger extends.

This configuration can give a plurality of types of illusionary tactile forces only by attaching the first vibration generator and the second vibration generator to a finger that is any finger of a hand of a user.

According to the present disclosure, with a simple structure, a plurality of types of illusionary tactile forces can be given while restrictions on the user's actions are reduced.

### BRIEF DESCRIPTION OF DRAWINGS

In the descriptions that follow, like parts are marked throughout the specification and drawings with the same numerals, respectively. The drawings are not necessarily drawn to scale and certain drawings may be shown in exaggerated or generalized form in the interest of clarity and conciseness. The disclosure itself, however, as well as a mode of use, further features and advances thereof, will be understood by reference to the following detailed description of illustrative implementations of the disclosure when read in conjunction with reference to the accompanying drawings, wherein:

FIG. 1 is an outside perspective view illustrating a portion, of an illusionary tactile force generating device to be attached to a hand, in accordance with aspects of the present disclosure;

FIG. 2 is an outside perspective view illustrating a state where the illusionary tactile force generating device attached to a hand, in accordance with aspects of the present disclosure;

FIG. 3 is a functional block diagram of the illusionary tactile force generating device in accordance with aspects of the present disclosure;

FIG. 4A is a view illustrating an image of an illusionary tactile force that causes a sensation that a hand is moving forward in a fingertip direction, in accordance with aspects of the present disclosure;

FIG. 4B is a view illustrating an image of an illusionary tactile force that causes a sensation that the hand is moving backward in a base direction, in accordance with aspects of the present disclosure;

FIG. 5 is a view illustrating an image of an illusionary tactile force that causes a sensation that an object comes into contact with a fingertip in accordance with aspects of the present disclosure;

FIG. 6 is an outside perspective view illustrating a portion, of an illusionary tactile force generating device to be attached to a hand, in accordance with aspects of the present disclosure;

FIG. 7 is an outside perspective view illustrating a portion, of an illusionary tactile force generating device to be attached to a hand, in accordance with aspects of the present disclosure;

FIG. 8 is a plan view illustrating a portion, of an illusionary tactile force generating device to be attached to a hand, in accordance with aspects of the present disclosure;

FIG. 9A is an outside perspective view illustrating a derivative example of an attachment unit in accordance with aspects of the present disclosure;

FIG. 9B is an outside perspective view of a main body of the attachment unit in accordance with aspects of the present disclosure; and

FIG. 9C is an outside perspective view of a fixing member of the attachment unit in accordance with aspects of the present disclosure.

### DETAILED DESCRIPTION

Hereinbelow, aspects of the present disclosure will be described. In a following description of the drawings, the same or similar components will be represented with use of the same or similar reference characters. The drawings are exemplary, sizes or shapes of portions are schematic, and technical scope of the present disclosure should not be understood with limitation to the aspects.

An illusionary tactile force generating device according to an aspect of the present disclosure will be described with reference to the drawings.

FIG. 1 is an outside perspective view illustrating a portion, of the illusionary tactile force generating device according to an aspect of the disclosure, to be attached to a hand.

As illustrated in FIG. 1, an illusionary tactile force generating device 20 includes a vibration generator 21, a vibration generator 22, an attachment unit 291, an attachment unit 292, and a signal cable 299. The signal cable 299 includes a signal cable 2991 and a signal cable 2992. The vibration generator 21 corresponds to a “first vibration generator”, and the vibration generator 22 corresponds to a “second vibration generator”. The attachment unit 291 corresponds to a “first attachment unit”, and the attachment unit 292 corresponds to a “second attachment unit”.

The vibration generator 21 and the vibration generator 22 are composed of different types of actuators. Specifically, the vibration generator 21 is composed of, for example, a linear resonant actuator (LRA) or a voice coil motor. The vibration generator 22 is composed of, for example, a piezoelectric actuator.

The vibration generator 21 is connected to the signal cable 2991. Accordingly, a first drive signal S1 is supplied to the vibration generator 21 through the signal cable 2991. The first drive signal S1 vibrates the vibration generator 21. The vibration direction of the vibration generator 21 is parallel to the direction connecting a first end portion E11 and a second end portion E12 of the vibration generator 21. The vibration by the vibration generator 21 parallel to the direction connecting the first end portion E11 and the second end portion E12 is referred to as a first vibration.

The vibration generator 22 is connected to the signal cable 2992. Accordingly, a second drive signal S2 is supplied to the vibration generator 22 through the signal cable 2992. The second drive signal S2 vibrates the vibration generator 22. The vibration direction of the vibration generator 22 can be a plurality of directions and includes at least a direction parallel to the direction connecting a first end portion E21 and a second end portion E22 of the vibration generator 22. The vibration by the vibration generator 22 is referred to as a second vibration, and the vibration parallel to the direction connecting the first end portion E21 and the second end portion E22 of the vibration generator 22 is referred to as a first mode of the second vibration.

The attachment unit 291 and the attachment unit 292 are made of a flexible material and a material capable of propagating a vibration.

The attachment unit 291 is a tubular body (a first tubular body) and has a through-hole 2910. The through-hole 2910 has a size through which a finger can be inserted. The attachment unit 292 is a tubular body (a second tubular body) and has a through-hole 2920. The through-hole 2920 has a size through which a finger can be inserted.

The vibration generator 21 is fixed to an outer peripheral surface of the attachment unit 291. At this time, an axis of the first vibration of the vibration generator 21 is parallel to the direction in which the tubular body of the attachment unit 291 extends.

The vibration generator 22 is fixed to an outer peripheral surface of the attachment unit 292. At this time, an axis of the first mode of the second vibration of the vibration generator 22 is parallel to the direction in which the tubular body of the attachment unit 292 extends.

Being “parallel” described above is not limited to being completely parallel, and may have a fixed error within a range in which an illusionary tactile force to be described later is given.

Each of the attachment unit 291 and the attachment unit 292 is not limited to a simple tubular body and may have a structure formed by deforming a band shape into a tubular shape.

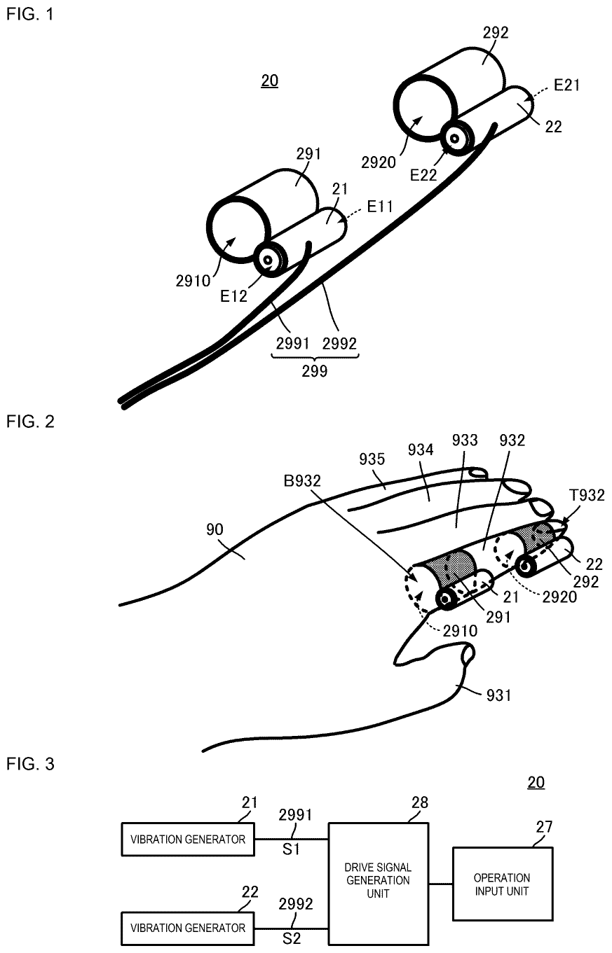

FIG. 2 is an outside perspective view illustrating a state where the illusionary tactile force generating device according to an aspect of the disclosure, which is attached to a hand. FIG. 2 illustrates a case in which the illusionary tactile force generating device is attached to the index finger of the left hand.

As illustrated in FIG. 2, the attachment unit 291 and the attachment unit 292 are attached to an index finger 932 of a hand 90. In other words, the index finger 932 is inserted into the through-hole 2910 of the attachment unit 291 and the through-hole 2920 of the attachment unit 292. At this time, the inner surfaces of the attachment unit 291 and the attachment unit 292 are in close contact with the index finger 932 in a state where a predetermined pressure is applied. Surfaces (opening surfaces of the through-hole 2910 and the through-hole 2920) orthogonal to the direction in which the index finger 932 is inserted into the attachment unit 291 and the attachment unit 292 are attachment surfaces of the attachment unit 291 and the attachment unit 292.

The attachment unit 291 is attached between a base B932 and a second joint of the index finger 932. The attachment unit 292 is attached between a fingertip T932 and a first joint of the index finger 932. That is, the attachment unit 291 and the attachment unit 292 are attached in the order of the attachment unit 291 and the attachment unit 292 from the base B932 toward the fingertip T932 of the index finger 932 in the direction in which the index finger 932 extends.

As a result, the vibration generator 21 and the vibration generator 22 are attached in the order of the vibration generator 21 and the vibration generator 22 from the base B932 toward the fingertip T932 of the index finger 932 in the direction in which the index finger 932 extends.

With this configuration, the user to whom an illusionary tactile force is given can wear the vibration generator 21 and the vibration generator 22 without holding the vibration generators 21 and 22 using the entire hand or the like. As a result, the illusionary tactile force generating device 20 can give an illusionary tactile force without decreasing the degree of freedom in use of the user's hand.

The finger to which the illusionary tactile force generating device 20 is attached is not limited to the index finger 932, and may be any one of a middle finger 933, a ring finger 934, and a little finger 935. However, the finger is preferably the index finger 932 or the little finger 935. In addition, for example, in the case of the index finger 932, the vibration generator 21 and the vibration generator 22 are preferably disposed on a side surface of the index finger 932 on a side opposite to the middle finger 933 side.

In addition, the illusionary tactile force generating device 20 is not limited to being attached to the left hand. When an illusionary tactile force is intended to be given to the left hand, the illusionary tactile force generating device 20 is attached to the left hand. When the illusionary tactile force is intended to be given to the right hand, the illusionary tactile force generating device 20 is attached to the right hand.

FIG. 3 is a functional block diagram of the illusionary tactile force generating device according to an aspect of the present disclosure.

As illustrated in FIG. 3, the illusionary tactile force generating device 20 includes the vibration generator 21, the vibration generator 22, an operation input unit 27, a drive signal generation unit 28, the signal cable 2991, and the signal cable 2992.

The vibration generator 21 is connected to the drive signal generation unit 28 through the signal cable 2991. The vibration generator 22 is connected to the drive signal generation unit 28 through the signal cable 2992. The drive signal generation unit 28 is connected to the operation input unit 27.

The operation input unit 27 receives a selection input of a type of illusionary tactile force to be given to the user. The operation input unit 27 outputs the type of illusionary tactile force to the drive signal generation unit 28.

The drive signal generation unit 28 generates the first drive signal S1 and the second drive signal S2 based on the type of illusionary tactile force.

More specifically, the first drive signal is a signal for giving a first illusionary tactile force. The first illusionary tactile force is an illusionary tactile force that causes an illusion in the brain that the hand 90 is moving in a front-back direction.

The second drive signal is a signal for giving a second illusionary tactile force. The second illusionary tactile force is an illusionary tactile force that causes an illusion in the brain that an external force is applied to the finger 932. The second illusionary tactile force is, for example, an illusionary tactile force that can be given by a minute vibration of a portion between the fingertip T932 and the first joint. That is, the second illusionary tactile force is a different type of illusionary tactile force from the first illusionary tactile force. By setting a plurality of types for the second drive signal S2, a plurality of types of the second illusionary tactile force can be given. In this case, the second illusionary tactile force may include an illusionary tactile force similar to the first illusionary tactile force.

The first drive signal S1 and the second drive signal S2 can be achieved by adjusting a waveform, a frequency, an amplitude, and the like depending on the type of the illusionary tactile force.

The drive signal generation unit 28 supplies the first drive signal S1 to the vibration generator 21 through the signal cable 2991. The drive signal generation unit 28 supplies the second drive signal S2 to the vibration generator 22 through the signal cable 2992.

The vibration generator 21 generates a vibration along the axis of the first vibration (a vibration parallel to the direction in which the index finger 932 extends: the first vibration) based on the first drive signal S1. The first vibration is propagated to a portion between the base B932 and the second joint of the index finger 932 through the attachment unit 291. As a result, the illusionary tactile force generating device 20 gives the user the first illusionary tactile force by the first vibration to the index finger 932.

The vibration generator 22 generates a vibration along the axis of the second vibration (the second vibration) based on the second drive signal S2. The second vibration is propagated to a portion between the fingertip T932 and the first joint of the index finger 932 through the attachment unit 292. As a result, the illusionary tactile force generating device 20 gives the second illusionary tactile force by the second vibration to the index finger 932.

For example, the illusionary tactile force generating device 20 can give the user a set of the first illusionary tactile force and the second illusionary tactile force described below.

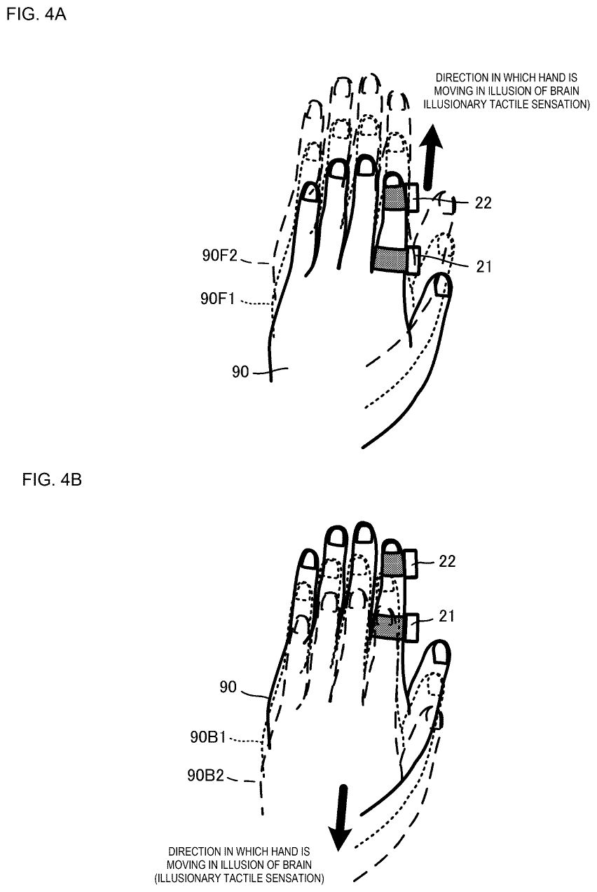

When the first drive signal S1 is given to the vibration generator 21, the vibration generator 21 generates a vibration (the first vibration) parallel to the direction in which the index finger 932 extends and gives the vibration to the index finger 932. As a result, the illusionary tactile force generating device 20 can generate, in the brain, an illusion that the hand is moving in the front-back direction as illustrated in FIGS. 4(A) and 4(B).

FIG. 4A is a view illustrating an image of an illusionary tactile force that causes a sensation that the hand is moving forward (in a fingertip direction), and FIG. 4B is a view illustrating an image of an illusionary tactile force that causes a sensation that the hand is moving backward (in a base direction).

Specifically, as illustrated in FIG. 4A, the illusionary tactile force of the forward movement of the hand is an illusionary tactile force that generates, in the brain, an illusion that the hand 90 is moving in the fingertip direction although the hand 90 is not actually moving.

As illustrated in FIG. 4B, the illusionary tactile force of the backward movement of the hand is an illusionary tactile force that generates, in the brain, an illusion that the hand 90 is moving in a wrist direction (the base direction of the finger) although the hand 90 is not actually moving.

At this time, by giving the vibration generator 22 a drive signal that synchronizes with the first drive signal S1, the vibration generator 22 can also give the index finger 932 a vibration similar to that of the vibration generator 21. As a result, the illusionary tactile force generating device 20 can more effectively cause an illusion that the hand is moving in the front-back direction.

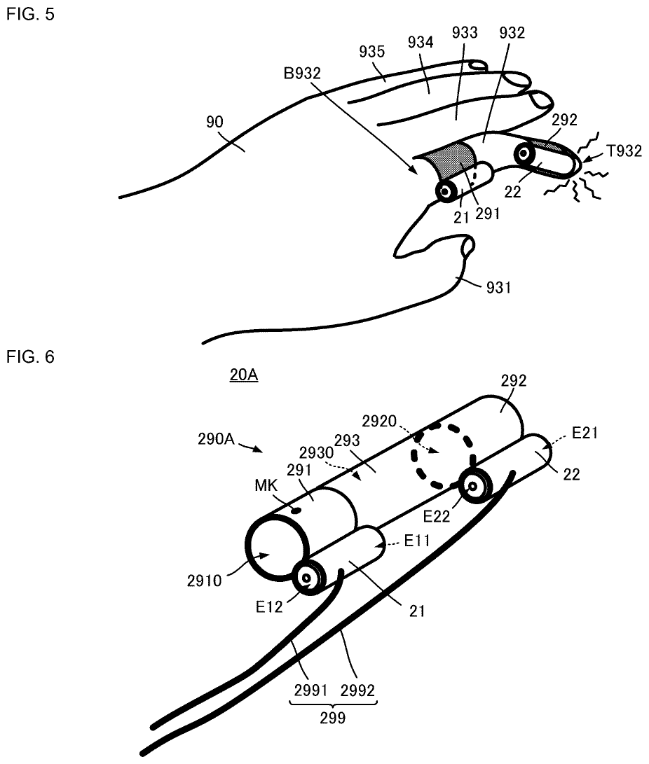

When the second drive signal S2 is given to the vibration generator 22, the vibration generator 22 generates a vibration and gives the vibration to the index finger 932. As a result, the illusionary tactile force generating device 20 can generate, in the brain, an illusion that an object comes into contact with the fingertip as illustrated in FIG. 5. At this time, the direction of the vibration (the second vibration) generated by the vibration generator 22 is not particularly limited, and may be any vibration.

FIG. 5 is a view illustrating an image of an illusionary tactile force that causes a sensation that an object comes into contact with the fingertip.

As illustrated in FIG. 5, the illusionary tactile force that causes a sensation that an object comes into contact with the fingertip is an illusionary tactile force that generates, in the brain, an illusion that the fingertip T932 and the vicinity of the fingertip T932 (specifically, a portion between the fingertip T932 and the first joint) are touching an object although the fingertip T932 and the vicinity of the fingertip T932 are not actually touching anything except the second attachment unit.

As described above, the illusionary tactile force generating device 20 can give a plurality of types of illusionary tactile forces only by attaching the vibration generator 21 and the vibration generator 22 to one finger 932 of the user. As a result, the illusionary tactile force generating device 20 can give a plurality of types of illusionary tactile forces with a simple structure while reducing restrictions on the user's actions.

In addition, each of the vibration generator 21 and the vibration generator 22 has a length shorter than the length of the user's finger, and has a width substantially equal to or smaller than the width of the user's finger. As a result, the illusionary tactile force generating device 20 can reduce a sense of discomfort caused by the attachment of the illusionary tactile force generating device 20.

An illusionary tactile force generating device according to an aspect of the present disclosure will be described with reference to the drawings. FIG. 6 is an outside perspective view illustrating a portion, of the illusionary tactile force generating device according to an aspect of the present disclosure, to be attached to a hand.

As illustrated in FIG. 6, an illusionary tactile force generating device 20A according to an aspect is different from the illusionary tactile force generating device 20 according to an aspect described above, in that the illusionary tactile force generating device 20A includes an attachment unit 290A. Other configurations of the illusionary tactile force generating device 20A are the same as those of the illusionary tactile force generating device 20, and the description of the same parts will be omitted.

The illusionary tactile force generating device 20A includes the attachment unit 290A. The attachment unit 290A includes the attachment unit 291, the attachment unit 292, and a connecting portion 293. The attachment unit 291 and the attachment unit 292 have the configurations described above.

The connecting portion 293 is a tubular body and has a through-hole 2930. The connecting portion 293 physically connects the attachment unit 291 and the attachment unit 292. The attachment unit 291, the connecting portion 293, and the attachment unit 292 are connected in this order to form one cylindrical body.

As a result, the connecting portion 293 fixes the positional relationship between the attachment unit 291 and the attachment unit 292. The through-hole 2930 of the connecting portion 293 is in communication with the through-hole 2910 of the attachment unit 291 and the through-hole 2920 of the attachment unit 292.

With such a configuration, only by attaching the attachment unit 290A to the user, the attachment unit 291 and the attachment unit 292 are disposed at predetermined positions of the finger (between the base and the second joint, and between the fingertip and the first joint). As a result, the vibration generator 21 and the vibration generator 22 are disposed at predetermined positions of the finger (between the base and the second joint, and between the fingertip and the first joint).

Therefore, the illusionary tactile force generating device 20A can give a plurality of types of illusionary tactile forces with a simple structure while reducing restrictions on the user's actions, and can reliably give the plurality of types of illusionary tactile forces by easy attachment.

At this time, as illustrated in FIG. 6, for example, an attachment mark MK is preferably formed in the vicinity of one end (for example, a portion overlapping the attachment unit 291) of the attachment unit 290A in the direction in which the attachment unit 290A extends. Therefore, attaching of the illusionary tactile force generating device 20A, by the user, in a wrong direction can be prevented or reduced. The position and the shape of the attachment mark MK are not limited to those in the example of FIG. 6 and may be another position or shape as long as the user can recognize the attachment direction of the illusionary tactile force generating device 20A.

In the illusionary tactile force generating device 20A, in the attachment unit 290A, the connecting portion 293 may be made of a material different from a material of the attachment unit 291 and the attachment unit 292. For example, the attachment unit 291 and the attachment unit 292 preferably propagate a vibration more easily than the connecting portion 293 does, and the connecting portion 293 preferably gives a greater comfort in attachment than the attachment unit 291 and the attachment unit 292.

For example, each of the attachment unit 291 and the attachment unit 292 has a structure that has a constant thickness and comes into close contact with a finger, and the connecting portion 293 has a structure that easily stretches in a circumferential direction of the cylindrical shape and does not easily stretch in an axial direction of the cylindrical shape. As a result, while a vibration is efficiently propagated from the attachment unit 291 and the attachment unit 292 to the finger, the connecting portion 293 facilitates the attachment and stabilizes the positional relationship between the attachment unit 291 and the attachment unit 292.

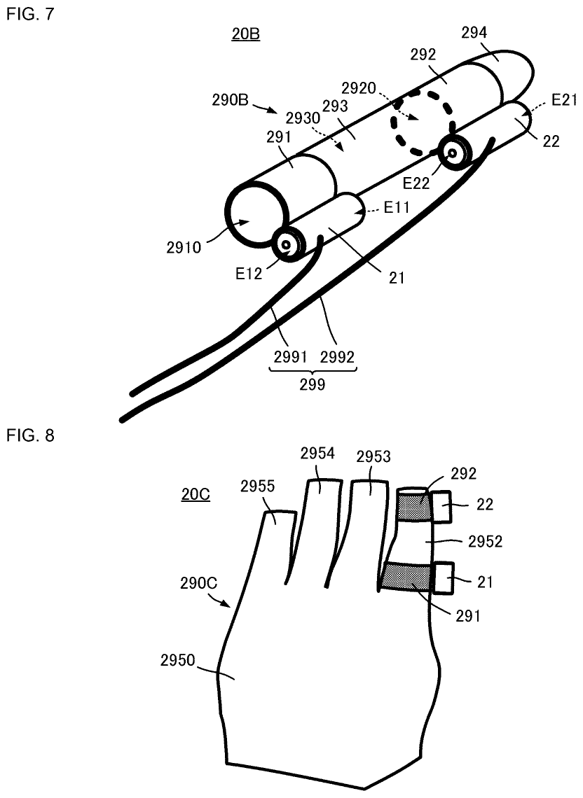

An illusionary tactile force generating device according to an aspect of the present disclosure will be described with reference to the drawings. FIG. 7 is an outside perspective view illustrating a portion, of the illusionary tactile force generating device according to an aspect of the present disclosure, to be attached to a hand.

As illustrated in FIG. 7, an illusionary tactile force generating device 20B according to an aspect of the present disclosure is different from the illusionary tactile force generating device 20A according to an aspect described above, in that the illusionary tactile force generating device 20B includes an attachment unit 290B. Other configurations of the illusionary tactile force generating device 20B are the same as those of the illusionary tactile force generating device 20A, and the description of the same parts will be omitted.

As illustrated in FIG. 7, the attachment unit 290B is different from the attachment unit 290A in that the attachment unit 290B includes a leading end portion 294. Specifically, the leading end portion 294 is connected to an end portion of the attachment unit 292 on a side opposite to the end portion connected to the connecting portion 293. The leading end portion 294 has a bag shape in which an end portion on a side opposite to the end connected to the attachment unit 292 is closed.

Therefore, the attachment unit 290B has a deep bag shape.

With such a configuration, when the user attaches the attachment unit 290B to his or her finger from the through-hole 2910, the fingertip fits into the leading end portion 294. As a result, the attachment unit 291 and the attachment unit 292 are disposed at predetermined positions of the finger (between the base and the second joint, and between the fingertip and the first joint). Accordingly, the vibration generator 21 and the vibration generator 22 are disposed at predetermined positions of the finger (between the base and the second joint, and between the fingertip and the first joint).

Therefore, the illusionary tactile force generating device 20B can give a plurality of types of illusionary tactile forces with a simple structure while reducing restrictions on the user's actions, and can more reliably give a plurality of types of illusionary tactile forces by easier attachment.

An illusionary tactile force generating device according to an aspect of the present disclosure will be described with reference to the drawings. FIG. 8 is a plan view illustrating a portion, of the illusionary tactile force generating device according to an aspect of the present disclosure, to be attached to a hand.

As illustrated in FIG. 8, an illusionary tactile force generating device 20C according to an aspect of the present disclosure is different from the illusionary tactile force generating device 20 according to an aspect described above, in that the illusionary tactile force generating device 20C includes an attachment unit 290C. Other configurations of the illusionary tactile force generating device 20C are the same as those of the illusionary tactile force generating device 20, and the description of the same parts will be omitted.

As illustrated in FIG. 8, the attachment unit 290C has a glove shape. The attachment unit 290C includes a main body portion 2950 that covers the back of the hand and the palm of the hand, and a plurality of finger insertion portions 2952, 2953, 2954, and 2955.

The attachment unit 291 is disposed near the end portion of the finger insertion portion 2952 connected to the main body portion 2950. For example, one end of the attachment unit 291 (an end on a side opposite to the attachment unit 292 side) is located at substantially the same position as the end portion of the finger insertion portion 2952 connected to the main body portion 2950. The attachment unit 292 is disposed near the leading end portion, of the finger insertion portion 2952, on a side opposite to the end portion connected to the main body portion 2950. For example, one end of the attachment unit 292 (an end on a side opposite to the attachment unit 291 side) is located at substantially the same position as the leading end portion of the finger insertion portion 2952.

With such a configuration, when the user attaches the attachment unit 290C to his or her hand, the attachment unit 291 and the attachment unit 292 are disposed at predetermined positions of the finger (between the base and the second joint, and between the fingertip and the first joint). As a result, the vibration generator 21 and the vibration generator 22 are disposed at predetermined positions of the finger (between the base and the second joint, and between the fingertip and the first joint).

Therefore, the illusionary tactile force generating device 20C can give a plurality of types of illusionary tactile forces with a simple structure while reducing restrictions on the user's actions, and can more reliably give a plurality of types of illusionary tactile forces by easier attachment.

Although the attachment unit 290C has a shape that covers the entire back of the hand and the entire palm of the hand in the above description, the attachment unit 290C need only have a shape that covers at least a part of the back of the hand and at least a part of the palm of the hand. In addition, the finger insertion portions in which the attachment unit 291 and the attachment unit 292 are not disposed can be omitted.

In the above-described aspects, flexible attachment units are exemplified. However, as an example, an attachment unit having a structure described below can be used.

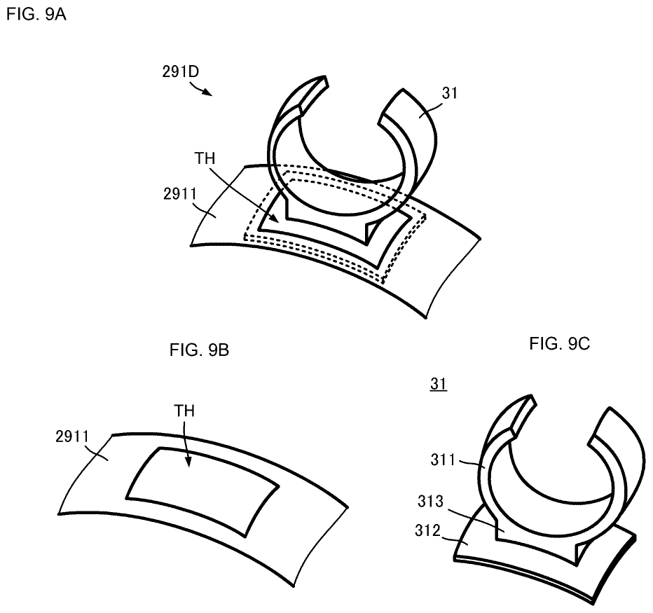

FIG. 9A is an outside perspective view illustrating a derivative example of an attachment unit, FIG. 9B is an outside perspective view of a main body of the attachment unit, and FIG. 9C is an outside perspective view of a fixing member of the attachment unit.

An attachment unit 291D of the derivative example can be replaced with the attachment unit 291 and the attachment unit 292 described above.

The attachment unit 291D includes a main body 2911 and a fixing member 31. The main body 2911 corresponds to a “first main body” and a “second main body”, and the fixing member 31 corresponds to a “first fixing member” and a “second fixing member”.

The main body 2911 is a band body or a tubular body. The main body 2911 is preferably flexible and stretchable. The main body 2911 has a through-hole TH.

The fixing member 31 is made of a material harder than the main body 2911 and a material that easily propagates a vibration. The fixing member 31 includes a holding member 311, a base member 312, and a support 313. The holding member 311, the base member 312, and the support 313 are, for example, integrally formed.

The holding member 311 is an annular body in which a part of a peripheral wall is removed. The vibration generator 21 and the vibration generator 22 are attached to the holding member 311.

The base member 312 has a shape having a curve corresponding to the shape of a finger. The holding member 311 is fixed to the base member 312 using the support 313.

The fixing member 31 is disposed in the main body 2911 in a state where the support 313 is inserted into the through-hole TH.

In this configuration, when the user attaches the main body 2911 to his or her finger, the attachment unit 291D is fixed in a state where the support 313 of the fixing member 31 abuts on a surface of the finger. Since the support 313 is made of a material that easily propagates a vibration, the vibration generated in the vibration generator 21 (the vibration generator 22) is effectively propagated to the finger of the user.

Therefore, an illusionary tactile force generating device including the attachment unit 291D can more effectively give an illusionary tactile force to the user.

In the above description, a mode in which the main body 2911 has the through-hole TH in the attachment unit 291D is described. However, a structure in which a bag portion having an opening is formed for the main body 2911 and the support 313 is inserted into the bag portion can also be used.

With this configuration, the support 313 comes into contact with the finger via a bottom portion of the bag portion, but having the bottom portion can reduce the damage to the finger compared to a case in which the support 313 directly comes into contact with the finger, and making the bottom portion thin can reduce a decrease in effect of effectively giving an illusionary tactile force to the user.

In general, the description of the aspects disclosed should be considered as being illustrative in all respects and not being restrictive. The scope of the present disclosure is shown by the claims rather than by the above description, and is intended to include meanings equivalent to the claims and all changes in the scope. While preferred aspects of the invention have been described above, it is to be understood that variations and modifications will be apparent to those skilled in the art without departing from the scope and spirit of the invention.

### DESCRIPTION OF REFERENCE SYMBOLS

20, 20A, 20B, 20C illusionary tactile force generating device
21, 22 vibration generator
27 operation input unit
28 drive signal generation unit
31 fixing member
90 hand
290A, 290B, 290C, 291, 291D, 292 attachment unit
293 connecting portion
294 leading end portion
299, 2991, 2992 signal cable
311 holding member
312 base member
313 support
932 finger
933 middle finger
934 ring finger
935 little finger
2910, 2920, 2930 through-hole
2911 main body
2950 main body portion
2952 finger insertion portion
B932 base
E11, E21 first end portion
E12, E22 second end portion
MK attachment mark
S1 first drive signal
S2 second drive signal
T932 fingertip
TH through-hole

We claim:

1. An illusionary tactile force generating device comprising:
a first vibration generator configured to generate a first vibration for generating a first illusionary tactile force;
a second vibration generator configured to generate a second vibration for generating a second illusionary tactile force;
a first attachment unit configured to attach the first vibration generator to a finger located on a hand of a user; and
a second attachment unit configured to attach the second vibration generator to the finger of the user,
wherein the first vibration and the second vibration are different vibration patterns with respect to each other, and
wherein the first attachment unit and the second attachment unit are disposed at different positions in a direction parallel to an extension of the finger of the user.

2. The illusionary tactile force generating device according to claim 1, wherein the first vibration generator and the second vibration generator include different actuators with respect to each other.

3. The illusionary tactile force generating device according to claim 1, wherein the first attachment unit is a flexible first tubular body.

4. The illusionary tactile force generating device according to claim 3, wherein the second attachment unit is a flexible second tubular body.

5. The illusionary tactile force generating device according to claim 1, further comprising a connecting portion configured to connect the first attachment unit and the second attachment unit and secures a positional relationship between the first attachment unit and the second attachment unit.

6. The illusionary tactile force generating device according to claim 5, wherein the first attachment unit, the second attachment unit, and the connecting portion are formed of a single cylindrical body.

7. The illusionary tactile force generating device according to claim 6, wherein the single cylindrical body includes a closed leading end portion.

8. The illusionary tactile force generating device according to claim 1, wherein the first illusionary tactile force produces an illusion that the hand of the user is moving.

9. The illusionary tactile force generating device according to claim 8, wherein the second illusionary tactile force produces a second illusion that an external force is applied to a specific position of the finger of the user.

10. The illusionary tactile force generating device according to claim 9, wherein the first vibration generator is configured to generate a vibration parallel to the direction in which the finger of the user extends.

11. The illusionary tactile force generating device according to claim 1, wherein the first vibration generator and the second vibration generator are arranged in an order from a base toward a fingertip of the finger of the user.

12. The illusionary tactile force generating device according to claim 5, further comprising a glove including the first attachment unit, the second attachment unit, and the connecting portion, and configured to cover at least a portion of a back of the hand or a palm of the hand.

13. The illusionary tactile force generating device according to claim 1, wherein the first attachment unit further includes:
a flexible first main body, and
a first fixing member that is disposed in the flexible first main body and to which the first vibration generator is fixed, and
wherein the first fixing member is harder than the flexible first main body.

14. The illusionary tactile force generating device according to claim 1, wherein the second attachment unit further includes:
a flexible second main body, and
a second fixing member that is disposed in the flexible second main body and to which the second vibration generator is fixed, and
wherein the second fixing member is harder than the flexible second main body.

15. An illusionary tactile force generating device comprising:
a first vibration generator configured to generate a first vibration for generating a first illusionary tactile force;
a second vibration generator configured to generate a second vibration for generating a second illusionary tactile force;
a first attachment unit configured to attach the first vibration generator to a finger located on a hand of a user; and
a second attachment unit configured to attach the second vibration generator to the finger of the user,
wherein the first vibration generator and the second vibration generator include different actuators with respect to each other.

16. The illusionary tactile force generating device according to claim 15, wherein the first illusionary tactile force produces an illusion that the hand of the user is moving.

17. The illusionary tactile force generating device according to claim 16, wherein the second illusionary tactile force produces a second illusion that an external force is applied to a specific position of the finger of the user.

18. The illusionary tactile force generating device according to claim 15, wherein the first attachment unit further includes:
a flexible first main body, and
a first fixing member that is disposed in the flexible first main body and to which the first vibration generator is fixed, and
wherein the first fixing member is harder than the flexible first main body.

19. The illusionary tactile force generating device according to claim 15, wherein the second attachment unit further includes:
a flexible second main body, and
a second fixing member that is disposed in the flexible second main body and to which the second vibration generator is fixed, and
wherein the second fixing member is harder than the flexible second main body.

20. An illusionary tactile force generating device comprising:
a first vibration generator configured to generate a first vibration for generating a first illusionary tactile force;
a second vibration generator configured to generate a second vibration for generating a second illusionary tactile force;
a first attachment unit configured to attach the first vibration generator to a finger located on a hand of a user; and
a second attachment unit configured to attach the second vibration generator to the finger of the user,
wherein the first attachment unit further includes:
a flexible first main body, and
a first fixing member that is disposed in the flexible first main body and to which the first vibration generator is fixed, and
wherein the first fixing member is harder than the flexible first main body, or
wherein the second attachment unit further includes:
a flexible second main body, and
a second fixing member that is disposed in the flexible second main body and to which the second vibration generator is fixed, and
wherein the second fixing member is harder than the flexible second main body.
